(19) United States
(12) Patent Application Publication
(10) Pub. No.: US 2015/0306597 A1
(43) Pub. Date: Oct. 29, 2015

(54) REDUNDANT MICROFLUIDIC MEASUREMENT TECHNIQUES

(71) Applicant: LIGHTSTAT, LLC, Southlake, TX (US)

(72) Inventor: Ayal Ram, Ramat Gan (IL)

(21) Appl. No.: 14/443,493

(22) PCT Filed: Nov. 18, 2013
(86) PCT No.: PCT/US2013/070509

§ 371 Date: May 18, 2015

Related U.S. Application Data
(60) Provisional application No. 61/796,651, filed on Nov. 16, 2012.

(51) Int. Cl. B01L 3/00

(52) U.S. Cl. CPC B01L 3/502715; B01L 2200/10; B01L 2300/0663; B01L 2300/0864; B01L 2300/12

(57) ABSTRACT

Techniques for redundant microfluidic measurements include a substrate in which is formed a microchannel in fluid communication between an entry port and an exit port. The microchannel includes a redundant portion that has multiple sub-channels. A first sub-channel is configured to pass a first fraction of a total flow passing through the entry port. The apparatus also includes a sensor configured to detect separate signals emitted from within the first sub-channel and from within a different sub-channel in the redundant portion of the microchannel.

### CROSS-REFERENCE TO RELATED APPLICATIONS

This application is a 371 national stage of PCT/US2013/070509 filed Nov. 18, 2013, which claims the benefit of U.S. Provisional Application No. 61/796,651 filed Nov. 16, 2012, the entire contents of which are hereby incorporated by reference in their entirety.

### BACKGROUND OF THE INVENTION

Multiplexed, sensitive, and on-chip molecular diagnostic assays are useful in both clinical and research settings. One method uses the binding of specific protein molecules to probes which have a very high specificity to that protein by use of immunochemical techniques. These techniques are continuously being developed to determine the presence of specific proteins in biological fluids. The analytical technique often involves the immobilization of the protein of choice to its specific probe, which is then measured using a variety of signaling technologies. The more sensitive the signaling process, the more accurate and precise is the immunochemical method. Still, many proteins are in such small quantities that the immunochemical procedure is not sensitive enough to detect them. Many detection strategies employ amplification schemes to achieve sensitivity by labeling surface bound targets for which measurements can be accumulated over long integration times. In standard amplification reactions such as the commercially available enzyme-linked immunosorbent assay (ELISA), enzyme-assisted amplification reactions occur on microplates with net volumes on the order of 100 μl and are still considered the gold standard for protein detection.

While suitable for many purposes, the immunochemical techniques available today are time consuming and require a multi-step analytical procedure. Also these procedures do not easily lend themselves to an analytical procedure by the bedside, since they require complex, large instrumentation and infrastructure. Furthermore, the present procedures can be adversely affected by antigen excess.

Antigen excess occurs if an antigen (e.g., a free light chain) to be measured is present in great excess. When the detection, method involves the precipitation of an antigen-antibody complexes, the great excess of antigen over antibody can lead to the formation of non-precipitating complexes, and therefore to poor detection or quantification, or some combination. This may lead to inaccurate or erroneous test results. This can also lead to erroneous results due to the fact that not all the antigen is bound to the antibody and therefore the signal is less than should be according to the true amount of antigen in the sample.

### SUMMARY OF THE INVENTION

It is herein recognized that it is advantageous to perform redundant analysis of a protein species using a miniature disposable device, which can be carried out in the absence of fixed or large instrumentation or infrastructure, or some combination.

In a first set of embodiments, an apparatus includes a substrate in which is formed a microchannel in fluid communication between an entry port and an exit port. The microchannel includes a redundant portion that has multiple sub-channels. A first sub-channel is configured to pass a first fraction of a total flow passing through the entry port. The apparatus also includes a sensor configured to detect separate signals emitted from within the first sub-channel and from within a different sub-channel of the in the redundant portion of the microchannel.

In a second set of embodiments, a method includes providing a microfluidic device comprising a substrate in which is formed a microchannel in fluid communication between an entry port and an exit port. The microchannel includes a redundant portion that has a plurality of sub-channels. A first sub-channel of the plurality of sub-channels is configured to pass a first fraction of a total flow passing through the entry port. The device also includes a sensor configured to detect separate signals emitted from within the first sub-channel and from within a different sub-channel of the plurality of sub-channels in the redundant portion of the microchannel. The method also includes moving a sample fluid from the entry port to the exit port. The method still further includes obtaining data from the sensor that indicates separate measurements of the signals emitted from within the first sub-channel and the different sub-channel during an observation period.

In a third set of embodiments, a kit includes a microfluidic device comprising a substrate in which is formed a microchannel in fluid communication between an entry port and an exit port. The microchannel includes a redundant portion that is made up f least a plurality of sub-channels. A first sub-channel of the plurality of sub-channels is configured to pass a first fraction of a total flow passing through the entry port. The device also includes a sensor configured to detect separate signals emitted from within the first sub-channel and a different sub-channel of the plurality of sub-channels in the redundant portion of the microchannel. The kit also includes a supply of a reagent selected to produce signals detectable at the sensor based on an analyte in a sample that passes through the microfluidic device.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an example apparatus for a redundant microfluidic measurement device, according to an embodiment;

FIG. 2 is a block diagram that illustrates example sub-channels and sensors for redundant measurements in a microfluidic device, according to an embodiment;

FIG. 3 is a flow diagram that illustrates an example method for performing a redundant microfluidic measurement using the device of FIG. 1, according to an embodiment;

FIG. 4A through FIG. 4C are block diagrams that illustrates example sub-channels for redundant measurements in a microfluidic device, according to another embodiment;

FIG. 5A through FIG. 5D are block diagrams that illustrates example sub-channels for redundant measurements in a microfluidic device, according to yet another embodiment;

FIG. 6 is a block diagram that illustrates example sub-channels for redundant measurements in a double sided microfluidic device, according to a further embodiment;

FIG. 7 is a block diagram that illustrates example sub-channels and sensors for redundant measurements in a microfluidic device, according to still another embodiment;

FIG. 8 is a block diagram that illustrates a computer system upon which an embodiment of the invention may be implemented; and

FIG. 9 illustrates a chip set upon which an embodiment of the invention may be implemented.

### DETAILED DESCRIPTION

A method and apparatus are described for redundant microfluidic measurements. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are described below in the context of analytes that are antigens and measurements based on precipitation; but, embodiments are not limited to this context. In other embodiments, one or more different analytes are sampled, or other measurement techniques are used, including luminesce, polarization, quantum dots, Förster resonance energy transfer (FRET), amplified colorimetric outputs using enzymes and substrates, among others, alone or in some combination. In some embodiments, the analytes are nucleic acids, such as DNA and RNA molecules or nucleic acid sequences, and detection is based on labeled probes in the precipitate or in solution.

As used herein, a microfluidic channel has at least one dimension in a size range from about 0.1 micron to about 1000 microns (1 micron, also called a micrometer, μm, =10⁻⁶ meters). Similarly, a microstructure has a greatest dimension in a range from about 1 micron to about 1000 microns.

The microfluidic measurement is performed on a sample from a subject. In various embodiments, the subject is an animal, typically a mammal, preferably a human, and the sample is a biological sample selected from the group consisting of hair, nails, serum, blood, peripheral blood, plasma, sputum, saliva, mucosal scraping, urine, pleural effusion fluid, cerebrospinal fluid, bone marrow, tissue biopsy, isolated cells or cell suspension on a scaffolding dissolved or suspended in aqueous or non-aqueous solution. In some illustrated embodiments, the analytes are proteins (such as antigens that stimulate a subject's immune system) and the probes are antibodies. In some embodiments, the subject is a food or inanimate object such as a vegetable or water body for human consumption.

### Overview

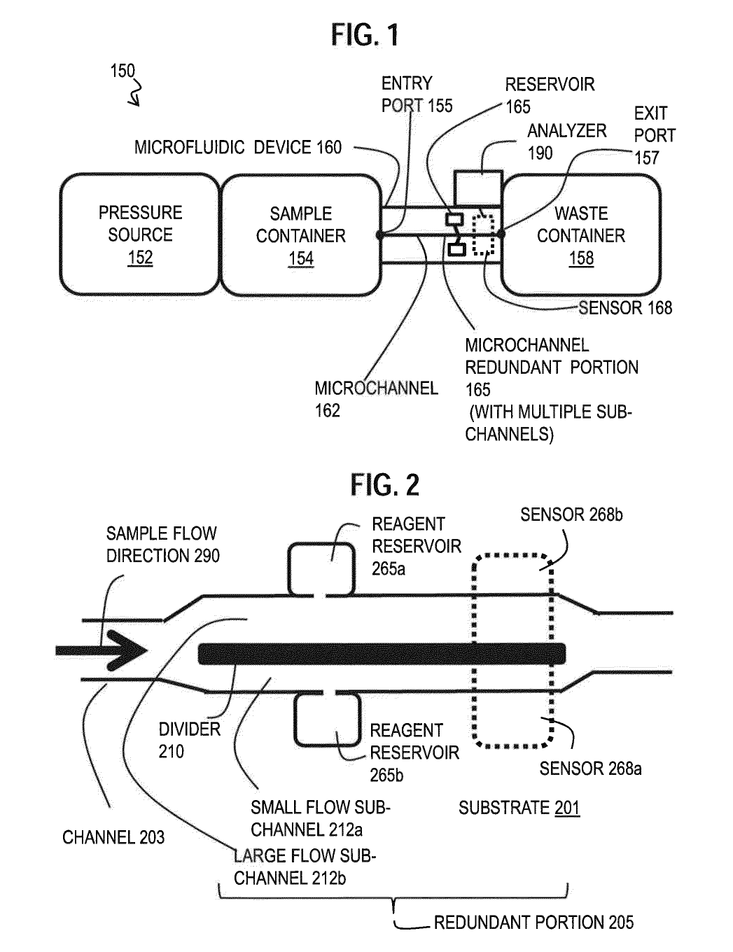

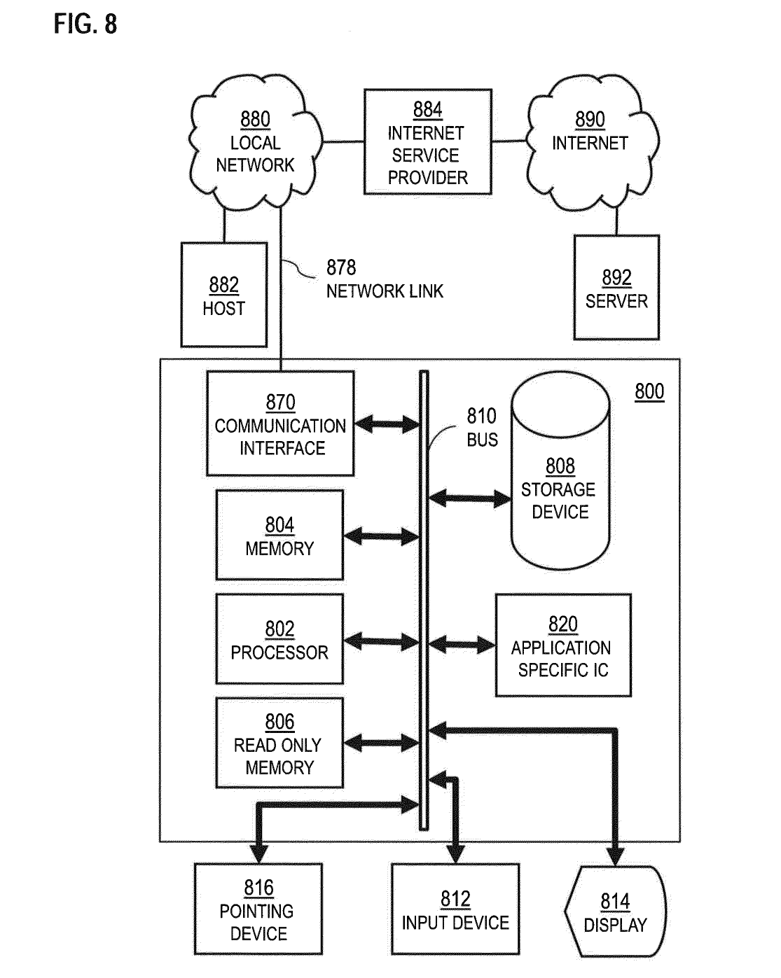

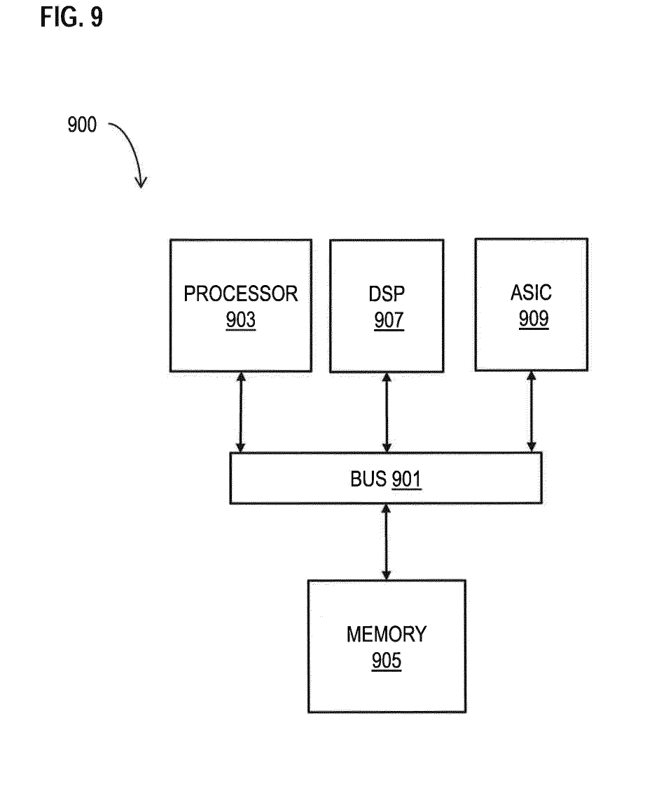

FIG. 1 is a block diagram that illustrates an example apparatus for a redundant microfluidic measurement device, according to an embodiment. The apparatus 150 includes a microfluidic device 160 having one or more microchannels in which at least one microchannel 162 includes a redundant portion 165 with multiple sub-channels. The product of reactions in the sub-channels, such as one or more colorimetric or fluorescent products, is observed by sensor 168, such as a photodetector or photodetector array, e.g. a charge coupled device (CCD) array. In some embodiments, the sensor 168 includes an optical source for exciting fluoresce, or optical components such as lenses and mirrors, or some combination. If the device is not transparent to the observations, then the device 160 includes an observation port (not shown) between the sensor 168 and the fix portion 166 of the microchannel 162. Analog or digital data from the sensor is analyzed by analyzer 190 to determine existence or relative or absolute quantity of one or more analytes or some combination in each of two or more sub-channel. In various embodiments, the analyzer 190 includes a computer system as described below with reference to FIG. 8 or a chip set as described below with reference to FIG. 9. In some embodiments, the analyzer 190 is a chip set 900 that is part of the microfluidic device 160.

Sample fluid is introduced into the microchannel 162 from a sample container 154 (e.g., pipette or absorbent pad). The fluid is propelled through the microchannel by a motive force, such as gravity, a micropump in the microchannel 162 or elsewhere in the microfluidic device 160, or by an external pressure source 152. Fluid passes out of each container 154 into the microchannel 162 through an entry port 155 (e.g., pipette needle) in the device 160. The fluid that passes through the microchannel exits through an exit port 157 and is ejected into a waste container 158. In some embodiments, the waste container is also part of the device 160. Thus described is a microfluidic device comprising a substrate in which is formed a microchannel in fluid communication between an entry port and an exit port. The pressure source or micro-pump constitutes an actuator configured to move a sample fluid from the entry port through the multiple sub-channels in the redundant portion 165 of the microchannel and then to the exit port.

In some embodiments, one or more reagents, such as labeled probes, for a reaction with an analyte to produce a product, such as a precipitate, observable by sensor 168 are provided by a reservoir connected to at least two sub-channels, such as reservoirs 165. In some embodiments, the reagents, such as labeled probes are inserted into each of two or more sub-channels of the microchannel 162, e.g., embedded in a hydrogel. In some these embodiments, the same amount of reagent is introduced in each sub-channel to test whether there is sign of analyte excess, such as antigen excess that leads to underreporting of antigen concentrations. In various embodiments, antigen-antibody complexes precipitate, although many do not. Even without precipitation, due to the usual amount of the antigen in the sample, a signal is not evident. In most cases, the signal measured is due to an activation of a signal molecule attached to the second antibody.

In some embodiments, one or more of the emissions received at sensors 168 are colorimetric emissions is response to a broadband light source, such as white or ambient light. In some embodiments, one or more of the emissions are fluorescent emissions in response to one or more excitation signals produced by the sensors 268a and 268b. In various embodiments, any electromagnetic or radioactive signals are emitted from the sub-channels and received by sensor 370. In example embodiments, the signals emitted are in or near the visible portion of the electromagnetic spectrum and referred to as optical signals. In various embodiments, the sensor includes one or more radioactive or electromagnetic or optical detectors, such as a charge coupled device (CCD) array, with zero or more radioactivity, electromagnetic or optical filters, to produce single pixel or image data responsive to the emissions.

In some embodiments, the analyzer 190 receives data from the sensor 168 and derives the presences, relative or absolute amount of one or more analytes based on the emissions detected, the affinities of the reaction between analytes and reagents, the efficiency of each reaction product to emit based on the ambient or excitation signals, the efficiency of the sensor 168, and the effects, if any, of any optical components, such as lenses, mirrors, optical path lengths, among others, alone or in some combination. The computations are based on the signal emitted or measured for a known standard or a standard curve. When the result is calculated from the measurement of the signal from a standard, it is simple triangulation computation. When the result is to be calculated from a standard curve, the result is taken from the point on the curve corresponding to the signal emitted from the unknown sample concentration.

FIG. 2 is a block diagram that illustrates example sub-channels and sensors for redundant measurements in a microfluidic device, according to an embodiment. This is a plan view cross section with the top and bottom of the diagram indicating the left and right relative to direction 290 of flow of a sample through the device. A channel 203 is formed in substrate 201. In a redundant portion 205 of channel 203, a divider 210, typically made of substrate material, divides the channel 203 into a small flow sub-channel 212a of smaller cross-sectional area and large flow sub-channel 212b of larger cross-sectional area. For purpose of illustration it is assumed that the depth of the channel and two sub-channels, perpendicular to the page, is the same. Thus the small flow sub-channel has smaller width than the large flow sub-channel. The percentage of the total flow through channel 230 that goes through each sub-channel is proportional to the relative cross sectional areas of the two sub-channels. Redundant portion 205 is thus a particular embodiment of redundant portion 165. The small flow sub-channel therefore carries substantively less than 50% of a total flow passing through the entry port. Substantively, as used herein means within negligible differences, such as within readily detectable levels. Thus, the microchannel comprises a redundant portion that comprises a plurality of sub-channels; and, a first sub-channel of the plurality of sub-channels is configured to pass a first fraction substantively less than 50% of a total flow passing through the entry port.

In some embodiments, to make comparison of measurement in the two sub-channels simpler, the large flow channel carries an integer multiple of the flow through the small flow sub-channel. For example, the large flow sub-channel width is twice the small flow sub-channel width so that the small flow sub-channel carries one third of the total flow and the large flow sub-channel carries two thirds, e.g., the large flow sub-channel carries the integer two times the flow through the small flow sub-channel. In other embodiments, other multiples are used, such as one quarter through the small flow sub-channel and the integer three times this amount through the large flow sub-channel; or, one fifth through the small flow sub-channel and the integer four times this amount through the large flow sub-channel; and so on. In some embodiments, the flow not passing through the small flow sub-channel passes through two or more larger flow sub-channels. For example, one sixth of the total sample flow passes through the small flow sub channel, two sixths through a different sub-channel and three sixths passes through the large sub-channel.

Thus, in various embodiments the small flow sub-channel carries a percentage of the total flow substantively between about 10% and about 40%. Thus, in some embodiments, the first fraction is in a range from about 10% to about 40%. In some of preferred embodiments, a different second sub-channel of the plurality of sub-channels is configured to carry a different second fraction of the total flow, and the second fraction is an integer multiple of the first fraction. In one of the embodiments described above, the first fraction is one quarter of the total flow and the second fraction is three quarters of the total flow. In another embodiment described above, the first fraction is one third of the total flow and the second fraction is two thirds of the total flow.

The same reagent in each of reservoirs 265a and 265b is dispensed into each channel, and a measurement is made separately in each sub-channel, such as by sensor 265a and sensor 265b, respectively. These two measurements can be combined (e.g., by analyzer 190) to provide better statistics. For example, an average value of the two measurements has a smaller random error than either measurement alone. With more sub-channels and corresponding sensors, the statistics are even better, all achieved with a single sample for a subject. After the measurement, the flow through all sub-channels is expelled through the same exit port, either a separate flows or as rejoined flows as depicted in FIG. 2. In some embodiments, the microfluidic device 160 is a small, inexpensive and disposable device.

In some embodiments, sensor 265a and 265b are two portions of the same sensor, such as different charge coupled devices (CCDs) in a CCD array of one or two dimensions.

In some embodiments, there is concern for measurement error due to analyte excess, such as antigen excess. To detect and reduce errors from analyte excess, in some embodiments, the same amount of reagent is dispensed from each reservoir into each sub-channel for which a measurement is made by the sensors 165. If the large flow sub-channel is subject to antigen excess that reduces precipitation and therefore detection by sensor 268b, then the small flow sub-channel, with more reagent per unit of sample fluid, is less subject to antigen excess or may avoid antigen excess altogether when the measurement is made by sensor 268a.

An advantage of splitting one microchannel into multiwell sub-channels is that some systems using inexpensive, disposable microfluidic chips, are already in use that provide one sample port and one waste port. None of those systems need be modified. The same single input and exit ports may be used. Instead, the one channel between entry port and exit port is divided internally into multiple sub-channels for redundant measurement or detection of analyte excess conditions. Thus, the microfluidic device is configured to couple to an existing sample container and waste container. In some embodiments, the sub-channels have substantively the same cross-sectional area and thus the result is based on unweighted averaging of the results from each channel. However if the channels are different in that each receives a multiple of the volume of the smallest channel, then the final result is calculated by multiplying the result found in the smaller channels by the appropriate weight (e.g., an integer multiple), and then an average result is forwarded as the final result.

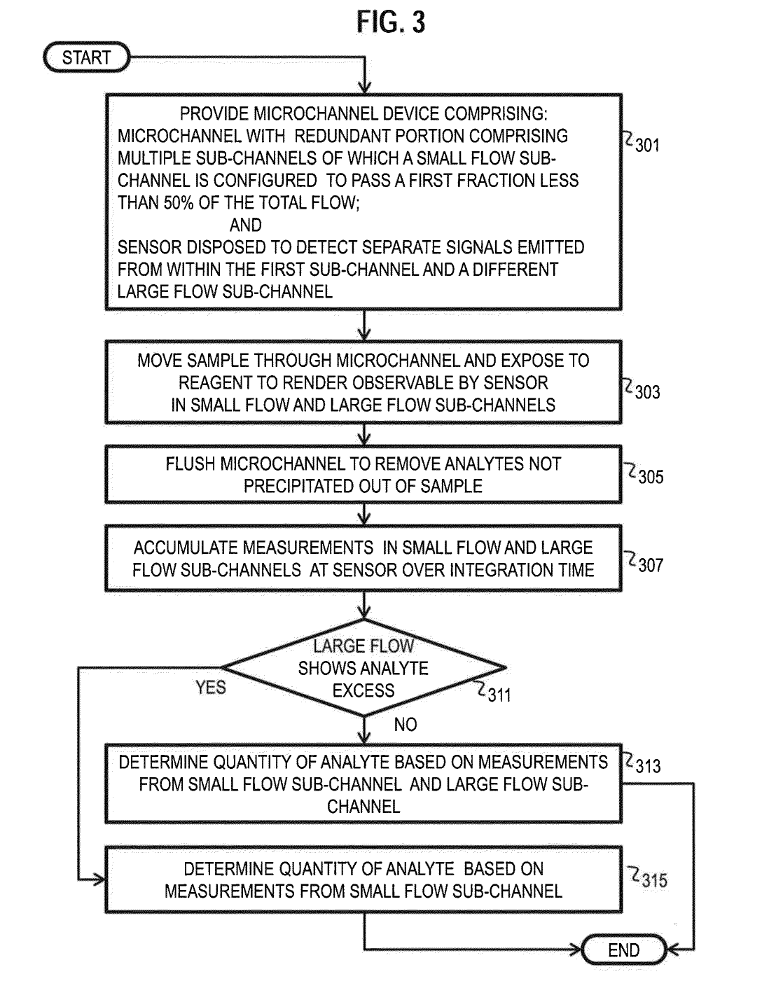

FIG. 3 is a flow diagram that illustrates an example method for performing a redundant microfluidic measurement using the device of FIG. 1, according to an embodiment. Although steps are shown as integral blocks in a particular order for purposes of illustration, in other embodiments, one or more steps, or portions thereof, are performed in a different order, or overlapping in time, in series or parallel, or are omitted; or other steps are added, or the process is changed in some combination of ways. For example, in some embodiments, a step is added to flush the microchannels with a buffer solution before step 303 to move a sample fluid through the microchannels.

In step 301, a microfluidic device, such as microfluidic device 160, is provided. In some embodiments, step 301 is achieved by obtaining a preformed device from a supplier. In some embodiments, step 301 includes fabricating the device. In some embodiments, step 301 is performed by one party and the other steps 303 through 315 are performed by one or more different parties.

For example, in some embodiments, microchannels and sub-channels are formed in polydimethylsiloxane (“PDMS”) using soft lithography. In some embodiments, channel inlets and outlets are punched, e.g., using a 15-gauge Luer stub; and channels are sonicated in ethanol and dried with argon gas prior to use. Glass slides (VWR, 24×60 mm) to serve as the top of the microchannels are soaked for 1 hour in a 1 M NaOH bath, rinsed with DI water, and dried using argon gas. In some embodiments, the PDMS channels and glass slides are plasma-treated (Harrick) on medium RF for 25 seconds, bonded together, and heated at 80 C for 20 minutes. In some embodiments, the micro-pump is inserted into a recess, such as a circular recess, formed in the substrate.

The function of a reagent is to react with an analyte to produce a product than can be detected by sensor 168. In some embodiments, the reagent is a labeled probe, where a probe is a molecule with affinity for binding to a specific analyte. The purpose of a labeled probe species is to bind to an analyte molecule in a sample and thus bind a label to the analyte. The probe molecule species is often a large biomolecule, such as a protein antibody or a strand of DNA complementary to at least a portion of an analyte DNA strand. The reagent also includes the same or different molecules to cause the labeled complexes to linger in view of the sensor, e.g., by precipitation and deposit on the microchannel or sub-channel walls.

The function of the label is to emit signals that can be detected and distinguished at the sensor 168, such as sensor 370. In some embodiments, the label is a non-fluorescent dye or fluorophore. Non-fluorescent dyes include chlorantine fast green, sirius red and Chicago blue. Colorimetric protein assay methods can be divided into two groups: those involving protein-copper chelation with secondary detection of the reduced copper and those based on protein-dye binding with direct detection of the color change associated with the bound dye. Example fluorophores used in various embodiments include one or more of Hydroxycoumarin, methoxycoumarin, Alexa fluor, aminocoumarin, Cy2, FAM, Alexa fluor, Fluorescein FITC, Alexa fluor, Alexa fluor, HEX, Cy3, TRITC, Alexa fluor, Alexa fluor, R-phycoerythrin (PE), Rhodamine Red-X, Tamara, Cy3.5, Rox, Alexa fluor 568, Red, Texas Red, Alexa fluor 594, Alexa fluor 633, Allophycocyanin, Alexa fluor 633 650, Cy5, Alexa fluor 660, Cy5.5, TruRed, Alexa fluor 680, Cy7.

In embodiments, that use an enzyme-substrate reaction to label the analyte molecule, the labeled probe molecule includes a portion that will bind strongly to the enzyme. For example, exploiting the high affinity of the biotin-streptavidin reaction, the labeled probe molecule is biotinylated in some embodiments. In other embodiments, the labeled probe molecule includes a streptavidin group and the enzyme includes the biotin. Embodiments that use an enzyme-substrate reaction to label the analyte molecule can produce stronger signals than obtained by directly labeling each analyte molecule with a single labeling molecule. Example enzymes include Horseradish peroxidase (HRP), and, in other embodiments, are any enzymes which catalyze a sensitive reaction leading to an identifiable, measurable, product, alone or in some combination.

In embodiments that use enzymes and substrates, example colorimetric substrates used with HRP include: 5-bromo, 4-chloro, 3-indolylphosphate (BCIP)/Nitro-Blue Tetrazolium (NBT); ABTS (2,2′-Azinobis[3-ethylbenzothiazoline-6-sulfonic acid]-diammonium salt); OPD (o-phenylenediamine dihydrochloride) [HRP]; MB (3,3′,5,5′-tetramethylbenzidine); and, 3-3′ diaminobenzidine tetrachloride. Example colorimetric substrates used with AP include p-Nitrophenyl Phosphate. Example colorimetric substrates used with B-galactosidase include 5-Bromo-4-Chloro-3-Indolyl β-D-Galactopyranoside. Instead of or in addition to colorimetric substrates, fluorescent substrates are used in some embodiments. Example fluorescent substrates used with HRP include amplex red (7-Hydroxy-3H-phenoxazin-3-one 10-oxide) which gets turned over to resorufin—sold by Life Technologies; and QuantaBlu Fluorogenic Peroxidase Substrate—sold by Thermo Scientific. Example fluorescent substrates used with AP include 2′-[2-benzothiazoyl]-6′-hydroxyberizothiazole phosphate [BBTP]—sold by Promega. Example fluorescent substrates used with B-galactosidase include Resorufin-B-galactopyranoside (RGB, Life Technologies); fluorescein-di-B-galactopyranoside (FDG, Life Technologies); and, 4-Methylumbelliferyl β-D-Galactopyranoside (MUG) 9H-(1,3-Dichloro-9,9-Dimethylacridin-2-One-7-yl) β-D-Galactopyranoside. In some embodiments, chemiluminescence substrates are used, such as ELISA HRP Substrates Crescendo and Forte from Luminata™; and NovaBright substrates and Galacton Star substrates from Life Technologies™.

In various embodiments, the sensor is selected from optical, electrochemical, fluorescent, or turbidimetric sensors, alone or in some combination.

In step 303, a sample fluid is moved from the entry port to the exit port. For example a pipette or absorbent pad or drop of blood from a pin prick is contacted to the entry port. The fluid is moved by gravity, capillary action, pressure front a pressure source 152, or by a micro-pump downstream of the redundant portion, or some combination. During step 303, the reagents are dispensed from the reservoirs (e.g., reservoirs 265a, 265b) to mix with the sample and bind to any of the corresponding analytes that are present in the sample. As a result, zero or more different labeled probe-analyte complexes are precipitated in view of the sensors 168. Thus, during step 303, a sample fluid is moved from the entry port to the exit port.

In step 305, the microchannel is flushed with an aqueous rinse solution that carries away unbound analytes, non-analytes, and non-precipitated labeled probe-analyte complexes. As a result, only the precipitated labeled analyte complexes remain in view of the sensors 168 (e.g., 268a, 268b). In some embodiments, step 305 is omitted.

A significant reaction is one in which some signal is obtained which is differentiable from background noise. Typically, this means that the signal divided by the noise generated by the assay is greater than 3—a widely accepted criteria in this field. The target concentration at which this ratio hits 3 is known based on a calibration curve that is generated. In other embodiments, this all differs based on the incubation conditions, the reaction times, and the types of probes/analytes and the affinities between them. In embodiments that use enzyme substrate reactions as a labeling means, step 405 includes a subsequent filling of the microchannel with substrate to produce fluorescent products that accumulate in the microchannel.

In step 307, a measurement is made of the observable product in each of two or more sub-channels during the observation period while the precipitated or un-precipitated labeled analyte complexes are excited. In some embodiments, the signaling mechanism involves the use of quantum dots, which, when excited, emit a signal at a specific wavelength. Quantum dots can be produced so that exciting different dots can result in the emission of a signal at different wavelengths, such that the probes for each analyte will emit a signal specific to that analyte. Thus, data is obtained from the sensor that indicates separate measurements of the signals emitted from within the first sub-channel and the different sub-channel during an observation period.

In step 311, it is determined, e.g., in analyzer 190, whether there is an indication of analyte excess (e.g., underreporting due to antigen excess) in the large flow sub-channel. For example, if the number of antigens detected in the large flow sub-channel is not proportionality larger than the count in the small flow sub-channel, then the large flow sub-channel is probably affected by antigen excess. If so, then in step 311 the analyte quantity is determined (e.g., by analyzer 190) based on one or more sub-channels that exclude the large-flow sub-channel. For example, the measurement in the large-flow sub-channel is ignored, and the count in the small flow channel is scaled up (e.g., by dividing the count by the fraction of the flow going through the small flow sub-channel or Rib-channels that do not indicate underreporting).

If it is determined in step 311, that there is no indication of analyte excess errors, then in step 313, the analyte quantity is determined (e.g., by analyzer 190) based on multiple measurements (e.g., averaging) from several different sub-channels. In some embodiments in which analyte excess is not expected to be an issue, steps 311 and 315 are omitted and flow passes directly from step 307 to step 313.

In some embodiments, calibration curves for analytes are determined by using a sample with known amounts of one or more analytes in step 303.

In some embodiments, a kit includes a microfluidic device comprising a substrate in which is formed a microchannel in fluid communication between an entry port and an exit port. The microchannel includes a redundant portion that is made up of at least a plurality of sub-channels. A first sub-channel of the plurality of sub-channels is configured to pass a first fraction less than 50% of a total flow passing through the entry port. The device also includes a sensor configured to detect separate signals emitted from within the first sub-channel and a different sub-channel of the plurality of sub-channels in the redundant portion of the microchannel. The kit also includes a supply of a reagent selected to produce signals detectable at the sensor based on an analyte in a sample that passes through the microfluidic device.

In some embodiments, the kit, or the device in the kit, also includes an analyzer configured to determine whether the signals emitted from within the different sub-channel are subject to analyte excess based on the data. In some of these embodiments, the analyzer is further configured to determine an amount of an analyte based on the measurement of the signals emitted from within the first sub-channel, if it is determined that the signals emitted from within the different sub-channel are subject to analyte excess. In some embodiments, the analyzer is further configured to determine an amount of the analyte based on the measurements of the signals emitted from within the first sub-channel and the different sub-channel, if it is determined that the signals emitted from within the different sub-channel are not subject to analyte excess.

### Example Embodiments

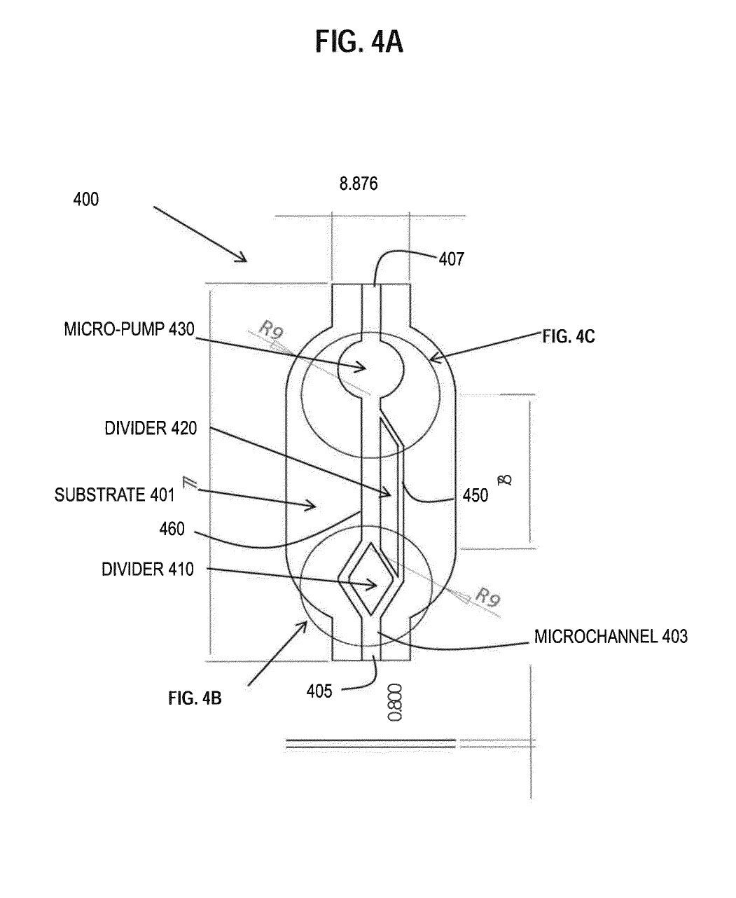

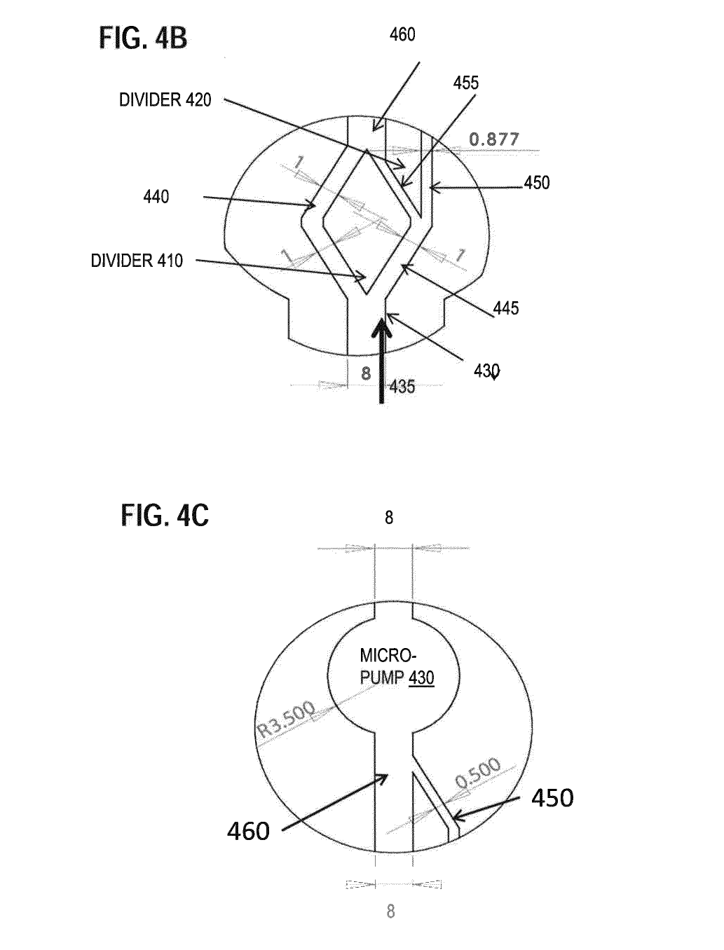

FIG. 4A through FIG. 4C are block diagrams that illustrates example sub-channels for redundant measurements in a microfluidic device, according to another embodiment. FIG. 4A displays a plan view of a single channel microfluidic device with two sub-channels 450, 460 and a micro-pump 430 according to this embodiment. The microchannel 403 is formed in substrate 401 and connects an entry port 405 to an exit port 407. The microchannel 403 is divided into several sub-channels by divider 410 and divider 420. FIG. 4A also indicates a micro-pump area enlarged in FIG. 4C and a fluid separation system enlarged in FIG. 4B.

FIG. 4B displays a plan view of a fluid separation system of the single channel microfluidic device. The fluid system 420 includes an inlet channel 430 connected to entry port 405. The inlet channel 430 separates in to sub-channel 440 and sub-channel 445 by divider 410 made of substrate material. The sub-channel 445 separates into sub-channel 450 and sub-channel 455 by divider 420. In the illustrated embodiment, the sub-channel 455 recombines with the sub-channel 440 to form sub-channel 460. FIG. 4C displays a view of the micro-pump area of the single channel microfluidic device with two sub-channels 450 and 460 and micro-pump 430. In one embodiment, the micro-pump, pumps whole blood though the micro-channel device with two sub-channels 450 and 460. Direction of flow 435 is indicated by an arrow.

During operation, a fluid such as whole blood enters the inlet channel 430. The inlet channel 430 separates in to sub-channel 440 and sub-channel 445. As a result 50% of the whole blood flows through sub-channel 440 and 50% of the whole blood flows through sub-channel 445. The sub-channel 445 separates in to sub-channel 450 and sub-channel 455. As a result, 25% of the whole blood flows through the sub-channel 450 and 25% of the whole blood flows through the sub-channel 455. In one embodiment, the sub-channel 455 recombines with the sub-channel 440 at sub-channel 460. Therefore, the 50% of the whole blood that passes through sub-channel 440 recombined with the 25% of the whole that passes through sub-channel 455 produces 75% of the whole blood at the sub-channel 460. It should be appreciated that although whole blood is used in the illustrated embodiment, a number of other liquids are within the scope of the present invention to include plasma, interstitial fluid, among others described above.

Thus, in this embodiment, the redundant portion of the microchannel includes a first flow divider 410 that divides flow from the entry port 405 into two substantively equal flows in a second sub-channel 440 and a third sub-channel 445. The third sub-channel includes a second flow divider 420 that divides flow in the third sub-channel 445 into two substantively equal flows in the first sub-channel 450 and a fourth sub-channel 455. In the illustrated embodiment, the fourth sub-channel 455 joins the second sub-channel 440 to form a fifth sub-channel 460 that carries substantively three quarters of the total flow. IN some of these embodiments, the sensor is configured to detect separate signals emitted from within the first sub-channel 450 and the fifth sub-channel 460.

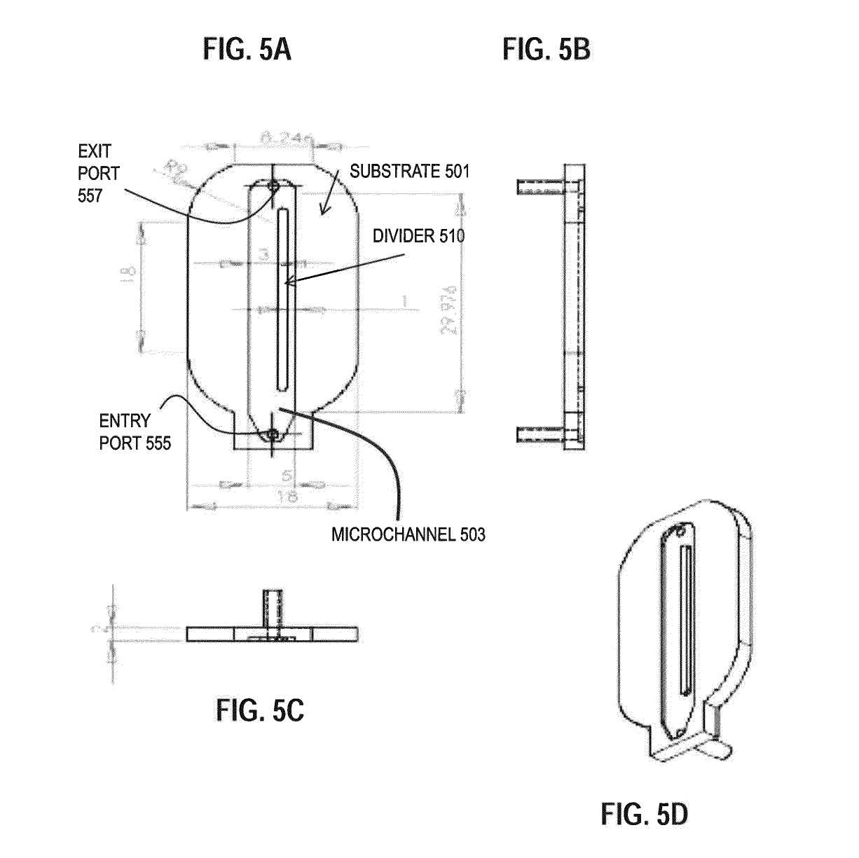

FIG. 5A through FIG. 5D are block diagrams that illustrates example sub-channels for redundant measurements in a microfluidic device, according to yet another embodiment. FIG. 5A is a plan view depicting microchannel 503 in substrate 501, with entry port 555 and exit port 557. One divider 510 generates two sub-channels. FIG. 5B provides a side view and FIG. 5C provides an end view. FIG. 5D provides a perspective view. As shown in FIG. 5C, both sub-channels have the same depth of 2 micrometers (μm, also called microns, 1 μm=10⁻⁶ meters). The small flow sub-channel has width 1 μm and the large flow sub-channel has width 3 μm, so 25% of the total flow passes through the small flow sub-channel and 75% passes through the large flow sub-channel.

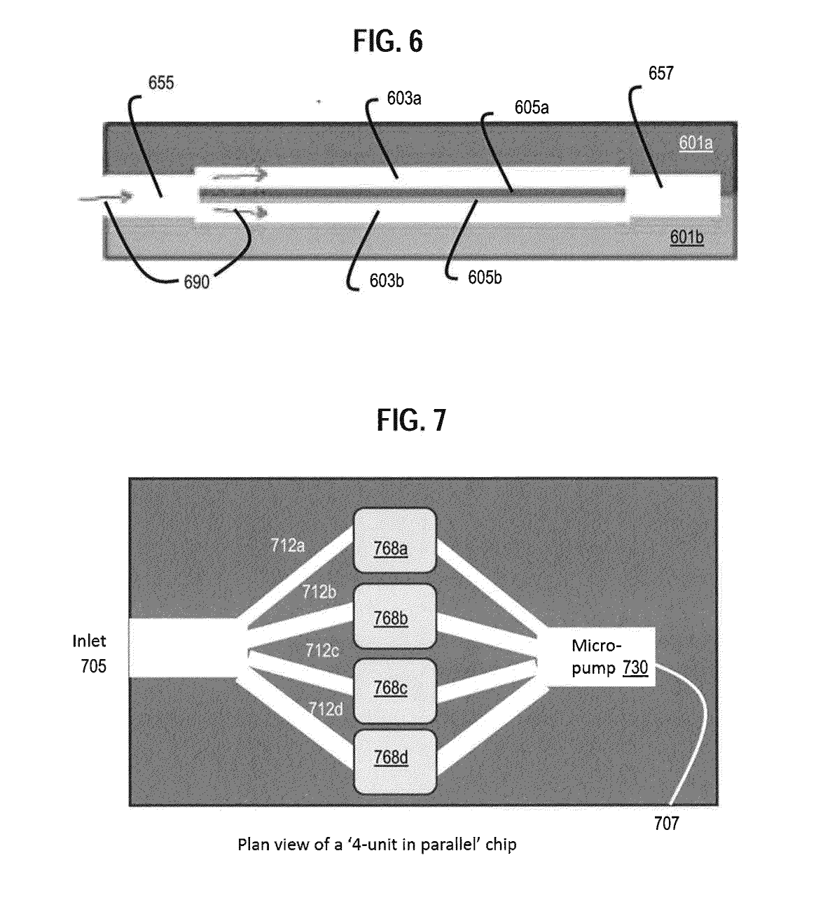

FIG. 6 is a block diagram that illustrates example sub-channels for redundant measurements in a double sided microfluidic device, according to a further embodiment. Two similar microchannels 603a, 603b in substrates 601a, 601b, respectively, each called a chip herein, are mounted face to face with joined entry ports 655 and exit ports 657. Between entry and exit ports, a cover 605a, 605b isolates the microchannel 603a, 603b, respectively. During operation, sample fluid with analyte flows into top and bottom chips in the directions given by the arrows 690. Detection is made separately in both top and bottom chips with sensors and reagents not shown, either in one microchannel per chip or several sub-channels in either or both chips. For example, two instances of the microchannel 503 in substrate 501 depicted in FIG. 5D attached to a cover plate (not shown in FIG. 5D but depicted in FIG. 6 as cover plates 605a and 605b) are placed face to face with a passage connected at entry port 555 and exit port 557.

FIG. 7 is a block diagram that illustrates example sub-channels and sensors for redundant measurements in a microfluidic device, according to still another embodiment. Entry port 705 is divided into four sub-channels 712a, 712b, 712c, 712d, e.g., carrying 10%, 20%, 30%, and 40%, respectively, of the total flow. Analyte in each sub-channel is measured separately using sensors 768a, 768b, 768c and 768d, respectively and associated reagents (not shown). The sample fluid is forced through the sub-channels, past the sensors and out the exit port 707 by a micro-pump 730 downstream of the sensors. If each sensor measures its corresponding multiple of the count found in sub-channel 712a (two, three and four times that count for sensors 768b, 768c, 768d, respectively) then that measurement is used, e.g., in a weighted average value, to improve statistics. However, if any measurement is not, e.g., is under-reported as expected for antigen excess, then the measurement of the sensor for that sub-channel is ignored, and the measurements from the remaining sub-channels are used.

### Analyzer Hardware Overview

FIG. 8 is a block diagram that illustrates a computer system 800 upon which an embodiment of the invention, such as analyzer 190, may be implemented. Computer system 800 includes a communication mechanism such as a bus 810 for passing information between other internal and external components of the computer system 800. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit).). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of one or more methods described herein.

A sequence of binary digits constitutes digital data that is used to represent a number or code for a character. A bus 810 includes many parallel conductors of information so that information is transferred quickly among devices coupled to the bus 810. One or more processors 802 for processing information are coupled with the bus 810. A processor 802 performs a set of operations on information. The set of operations include bringing information in from the bus 810 and placing information on the bus 810. The set of operations also typically include comparing two or more units of information, shifting positions of units of information, and combining two or more units of information, such as by addition or multiplication. A sequence of operations to be executed by the processor 802 constitute computer instructions.

Computer system 800 also includes a memory 804 coupled to bus 810. The memory 804, such as a random access memory (RAM) or other dynamic storage device, stores information including computer instructions. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of computer instructions. The computer system 800 also includes a read only memory (ROM) 806 or other static storage device coupled to the bus 810 for storing static information, including instructions, that is not changed by the computer system 800. Also coupled to bus 810 is a non-volatile (persistent) storage device 808, such as a magnetic disk or optical disk, for storing information, including instructions, that persists even when the computer system 800 is turned off or otherwise loses power.

Information, including instructions, is provided to the bus 810 for use by the processor from an external input device 812, such as a keyboard containing alphanumeric keys operated by a human user, or a sensor. A sensor detects conditions in its vicinity and transforms those detections into signals compatible with the signals used to represent information in computer system 800. Other external devices coupled to bus 810, used primarily for interacting with humans, include a display device 814, such as a cathode ray tube (CRT) or a liquid crystal display (LCD), for presenting images, and a pointing device 816, such as a mouse or a trackball or cursor direction keys, for controlling a position of a small cursor image presented on the display 814 and issuing commands associated with graphical elements presented on the display 814.

In the illustrated embodiment, special purpose hardware, such as an application specific integrated circuit (IC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet, Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 870 sends and receives electrical, acoustic or electromagnetic signals, including infrared and optical signals, that carry information streams, such as digital data.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 802, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 802, except for carrier waves and other signals.

Logic encoded in one or more tangible media includes one or both of processor instructions on a computer-readable storage media and special purpose hardware, such as ASIC 820.

Network link 878 typically provides information communication through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890. A computer called a server 892 connected to the Internet provides a service in response to information received over the Internet. For example, server 892 provides information representing video data for presentation at display 814.

The invention is related to the use of computer system 800 for implementing the techniques described herein. According to one embodiment of the invention, those techniques are performed by computer system 800 in response to processor 802 executing one or more sequences of one or more instructions contained in memory 804. Such instructions, also called software and program code, may be read into memory 804 from another computer-readable medium such as storage device 808. Execution of the sequences of instructions contained in memory 804 causes processor 802 to perform the method steps described herein. In alternative embodiments, hardware, such as application specific integrated circuit 820, may be used in place of or in combination with software to implement the invention. Thus, embodiments of the invention are not limited to any specific combination of hardware and software.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server 892 transmits program code for a particular application, requested by a message sent from computer 800, through Internet 890, ISP equipment 884, local network 880 and communications interface 870. The received code may be executed by processor 802 as it is received, or may be stored in storage device 808 or other non-volatile storage for later execution, or both. In this manner, computer system 800 may obtain application program code in the form of a signal on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red a carrier wave serving as the network link 878. An infrared detector serving as communications interface 870 receives the instructions and data carried in the infrared, signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention, such as analyzer 190, may be implemented. Chip set 900 is programmed to perform one or more steps of a method described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of a method described herein.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 905 also stores the data associated with or generated by the execution of one or more steps of the methods described herein.

### Extensions, Alterations, Modifications

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

What is claimed is:

1. A microfluidic device comprising;
a substrate in which is formed a microchannel in fluid communication between an entry port and an exit port, wherein
the microchannel comprises a redundant portion that comprises a plurality of sub-channels, and
a first sub-channel of the plurality of sub-channels is configured to pass a first fraction of a total flow passing through the entry port; and
a sensor configured to detect separate signals emitted from within the first sub-channel and a different sub-channel of the plurality of sub-channels in the redundant portion of the microchannel.

2. A device as recited in claim 1, wherein the first fraction is in a range from about 10% to about 40%.

3. A device as recited in claim 1, wherein a different second sub-channel of the plurality of sub-channels is configured to carry a different second fraction of the total flow, and the second fraction is an integer multiple of the first fraction.

4. A device as recited in claim 3, wherein the first fraction is one quarter of the total flow and the second fraction is three quarters of the total flow.

5. A device as recited in claim 3, wherein the first fraction is one third of the total flow and the second fraction is two thirds of the total flow.

6. A device as recited in claim 1, wherein the redundant portion of the microchannel further comprises:
a first flow divider that divides flow from the entry port into two substantively equal flows in a second sub-channel and a third sub-channel; and,
the third sub-channel includes a second flow divider that divides flow in the third sub-channel into two substantively equal flows in the first sub-channel and a fourth sub-channel.

7. A device as recited in claim 6, wherein the fourth sub-channel joins the second sub-channel to form a fifth sub-channel that carries substantively three quarters of the total flow.

8. A device as recited in claim 7, wherein the sensor is configured to detect separate signals emitted from within the first sub-channel and the fifth sub-channel.

9. A device as recited in claim 1, wherein the microfluidic device is disposable.

10. A device as recited in claim 1, wherein the microfluidic device is configured to couple to an existing sample container and waste container.

11. A method comprising:
providing a microfluidic device comprising
a substrate in which is formed a microchannel in fluid communication between an entry port and an exit port, wherein
the microchannel comprises a redundant portion that comprises a plurality of sub-channels, and
a first sub-channel of the plurality of sub-channels is configured to pass a first fraction of a total flow passing through the entry port; and
a sensor configured to detect separate signals emitted from within the first sub-channel and a different sub-channel of the plurality of sub-channels in the redundant portion of the microchannel;
moving a sample fluid from the entry port to the exit port; and
obtaining data from the sensor that indicates separate measurements of the signals emitted from within the first sub-channel and the different sub-channel during an observation period.

12. A method as recited in claim 11, further comprising determining whether the signals emitted from within the different sub-channel are subject to analyte excess based on the data.

13. A method as recited in claim 12, if it is determined that the signals emitted from within the different sub-channel are subject to analyte excess, then determining an amount of the analyte based on the measurement of the signals emitted from within the first sub-channel.

14. A method as recited in claim 12, if it is determined that the signals emitted from within the different sub-channel are not subject to analyte excess, then determining an amount of the analyte based on the measurements of the signals emitted from within the first sub-channel and the different sub-channel.

15. A kit comprising:
a microfluidic device comprising
a substrate in which is formed a microchannel in fluid communication between an entry port and an exit port, wherein
the microchannel comprises a redundant portion that comprises a plurality of sub-channels, and
a first sub-channel of the plurality of sub-channels is configured to pass a first fraction of a total flow passing through the entry port; and
a sensor configured to detect separate signals emitted from within the first sub-channel and a different sub-channel of the plurality of sub-channels in the redundant portion of the microchannel; and
a supply of a reagent selected to produce signals detectable at the sensor based on an analyte in a sample that passes through the microfluidic device.

16. A kit as recited in claim 15, further comprising an analyzer configured to determine whether the signals emitted from within the different sub-channel are subject to analyte excess based on the data.

17. A kit as recited in claim 16, the analyzer further configured determine an amount of the analyte based on the measurement of the signals emitted from within the first sub-channel, if it is determined that the signals emitted from within the different sub-channel are subject to analyte excess.

18. A kit as recited in claim 16, the analyzer further configured to determine an amount of the analyte based on the measurements of the signals emitted from within the first sub-channel and the different sub-channel, if it is determined that the signals emitted from within the different sub-channel are not subject to analyte excess.
